(19) United States
(12) Patent Application Publication
(10) Pub. No.: US 2009/0011076 A1
(43) Pub. Date: Jan. 8, 2009

(54) FEED FOR A HEN PRODUCING EGGS CONTAINING DHA, A METHOD FOR BREEDING HENS AND AN EGG PRODUCED THEREBY

(75) Inventor: Bin Yang, Dujun District (CN)

Correspondence Address: OBLON, SPIVAK, MCCLELLAND MAIER & NEUSTADT, P.C., 1940 DUKE STREET, ALEXANDRIA, VA, 22314, US

(73) Assignee: ISE FOODS INC., Konosu-shi (JP)

(21) Appl. No.: 12/040,201

(22) Filed: Feb. 29, 2008

(30) Foreign Application Priority Data
Mar. 2, 2007 (CN) 2007102002463

(51) Int. Cl. A23K 1/24; A23K 1/00

(52) U.S. Cl. 426/2; 426/601; 426/72

(57) ABSTRACT

This invention relates to feed for a hen producing eggs containing DHA, a method for breeding hens and eggs obtained thereby. The feed is mixed with 5 to 200 portions of oil obtained by squeezing Perilla seeds and dregs of the Perilla seeds to be a total of 1,000 portions. After breeding hens with the feed twice a day for more than four successive weeks, eggs containing 0.12% to 0.38% of DHA are obtained. The present invention can provide eggs, which are produced by hens fed with the feed added with oil obtained by squeezing Perilla seeds and with the Perilla seed dregs after being squeezed, highly containing DHA and ALA and has a good health effect compared with the conventional arts and keeping the original taste, lower the costs for breeding, and make the breeding effect better.

### BACKGROUND OF THE INVENTION

1. Field of the Invention

This invention relates to some kind of feed, usage thereof and products provided thereby, more specifically to feed for a hen producing eggs containing DHA, a usage thereof and egg products provided thereby.

2. Description of the Related Art

DHA is chemically called “docosahexaenoic acid.” Human cell membrane is a lipid bilayer consisted of a saturated fatty acid and an unsaturated fatty acid. The unsaturated fatty acid is DHA. In human body, brain cells contain much DHA and it plays an important role to human health. ALA is alpha-linolenic acid and chemically called “octadecatrienoic acid,” which transmits general signals and promotes and controls numerous physiologic processes in human body. In 1978, Derberg first reported that a low occurrence of angiocardiopathy in Greenland Eskimos related to a fact that they ate a lot of fish. In the recent 20 years, many studies have been provided concerning DHA and EPA contained abundantly in fish oil, showing that DHA and ALA have various effects of lowering the serum cholesterol, lowering the occurrence of angiocardiopathy and promoting the growth of brain and nerve tissue. Thus, So many kinds of fish oil products containing DHA have been developed such as SperuEPA-200 in America, Efand in Australia, and Marine Triglycerides in Wuxi, China. Although these fish oil products have health care effects, in the light of dieting habits, the acceptance of these products are restricted since they seem more likely to be a kind of medicine. Therefore, many manufacturers tried to produce DHA eggs. Such products so far are provided from hens bred with the feed containing additives such as fish oil, linseed and the like. However, such method of breeding not only costs much but also worsens the taste of eggs, which have fishy odor. It costs even more if other additives are applied to reduce the odor.

### SUMMARY OF THE INVENTION

The aim of this invention is to provide a new kind of feed for a hen producing eggs containing DHA, a method for using thereof and products provided thereby. Hens bred by this method can produce eggs highly containing DHA, keeping a taste of the egg and the cost therefor can be lowered.

In this invention, feed is mixed with 5 to 200 portions of oil obtained by squeezing Perilla seeds and dregs of the Perilla seeds to be a total of 1000 portions, thus feed for a hen producing eggs containing DHA is obtained.

In this invention, 0.02 to 0.8 portions of vitamin E and 0.01 to 0.3 portions of green tea polyphenol can also be added into the feed

Moreover, the 1000 portions of the mixed feed can comprise 650 to 895 portions of corn and bean dregs as main ingredients and 100 to 150 portions of vitamins, minerals, calcium and phosphorus as supplementary ingredients according to a conventional proportion.

The mixed feed should be fed to hens twice a day for four successive weeks.

The eggs produced by the hens contain 0.12 wt % to 0.38 wt % of DHA and 0.13 wt % to 0.57 wt % of octadecatrienoic acid.

DHA can effectively reduce the cholesterol in blood serum, lower the occurrence of angiocardiopathy, promote the growth of brain, vitalize cells, strengthen memory and prevent brain aging. It has a remarkable effect especially for pregnant women, children and old persons. It can effectively expand blood vessels, prevent arteriosclerosis, diabetes and cerebral thrombosis, reduce the quantity of neutral fat, triglyceride and cholesterol, promote the production of Pg3, inhibit blood coagulation, lower blood pressure and alleviate inflammation. It also has anti-cancer and anti-allergy effects, and lowers the fat in the blood and saturated fats.

Perilla seeds have specific fragrance. Perilla seeds contain oil up to 40% to 50% and alpha-linolenic acid 60% thereof. It has the most amount of alpha-linolenic acid among all the plants ever reported. Alpha-linolenic acid, the main component of Perilla, is matrix of ω-3 highly-unsaturated fatty acid, and it is the best recourse to supplement the ω-3 highly-unsaturated fatty acid that tends to lack in human body. Sea fish oil is rich in EPA and DHA. Perilla seeds are rich in ω-3 fatty acid, which exits in a form of EPA and DHA after being metabolized in human body. Since the number of double bonds of alpha-linolenic acid is less than that of EPA or DHA, Perilla oil is more stable against oxidation than fish oil. Fish oil contains cholesterol while Perilla oil does not. In terms of linseed, its alpha-linolenic acid content is only 50%, and eggs produced by hens fed with linseed in present market taste bad.

The present invention can provide eggs, which are produced by hens fed with the feed added with oil obtained by squeezing Perilla seeds and with the Perilla seed dregs after being squeezed, highly containing DHA and ALA and has a good health effect compared with the conventional arts and keeping the original taste, lower the costs for breeding, and make the breeding effect better.

### DETAILED DESCRIPTION OF THE PREFERRED EMBODIMENTS

### Example 1

Oil was squeezed from 200 portions of Perilla seeds according to a conventional method. The obtained Perilla seed oil and the Perilla seed dregs were added to 650 portions of commercial feed consisted of corn, bean dregs, bran coat, peanut dregs and so on as main ingredients, and 150 portions of various vitamins, trace elements (e.g. ferric oxide, cupric sulfate, etc.) and bone powder as supplementary ingredients. Moreover, 0.02 portions of vitamin E and 0.01 portions of green tea polyphenol were also added.

The eggs produced by the hens fed by the above-described feed contain 0.38 wt % of DHA and 0.57 wt % of ALA.

### Example 2

Oil was squeezed from 200 portions of Perilla seeds according to a conventional method. The obtained Perilla seed oil and the Perilla seed dregs were added to 895 portions of commercial feed consisted of corn, bean dregs, fish powder and so on as main ingredients, and 100 portions of various vitamins, trace elements (e.g. ferric oxide, cupric sulfate, etc.) and shell powder as supplementary ingredients various.

The eggs produced by the hens fed by the above-described feed contain 0.12 wt % of DHA and 0.13 wt % of ALA.

### Example 3

Oil was squeezed from 100 portions of Perilla seeds according to a conventional method. The obtained Perilla seed oil and the Perilla seed dregs were added to 770 portions of commercial feed consisted of corn and bean dregs as main ingredients, and 130 portions of various vitamins, trace elements (e.g. ferric oxide, cupric sulfate, etc.) and stone powder as supplementary ingredients. Moreover, 0.4 portions of vitamin E and 0.15 portions of green tea polyphenol were also added.

The eggs produced by the hens fed by the above-described feed contain 0.24 wt % of DHA and 0.27 wt % of ALA.

### Example 4

Oil was squeezed from 120 portions of Perilla seeds according to a conventional method. The obtained Perilla seed oil and the Perilla seed dregs were added to 880 portions of commercial corn feed.

The eggs produced by the hens fed by the above-described feed contain 0.22 wt % of DHA and 0.25 wt % of ALA.

### Example 5

Oil was squeezed from 150 portions of Perilla seeds according to a conventional method. The obtained Perilla seed oil and the Perilla seed dregs were added to 850 portions of commercial bran coat feed.

The eggs produced by the hens fed by the above-described feed contain 0.23 wt % of DHA and 0.26 wt % of ALA.

Each of the above-described feed was given to the hens twice a day for four successive weeks. This method of feeding can not only satisfy metabolizing energy for the hens but also make the hens sufficiently absorb octadecatrienoic acid in the feed and thus enable them to produce eggs containing necessary amount of docosahexaenoic acid octadecatrienoic acid.

Since birds do not have well-developed sense of taste, their food intake mainly depends on the energy amount of the feed. Namely, the more energy amount the feed has, the less food intake they have; the less energy amount, the more food intake. Therefore, the preparation of the feed with high energy content can reduce the amount feed and also the costs therefor.

Main ingredients of carbohydrate feed are starches and sugars, which occupy 70% of daily mixed feed. Since corn has the highest energy amount among all the grain feed, it occupies 45% to 70% in the mixed feed. Since bran coat has a good crispy taste and are rich in protein and phosphorus, it occupies 5% to 30% in the mixed feed. Since, however, the metabolizing capacity of its protein and phosphorus is not so high, it is not very good for being used for preparing the feed. Barley contains so much harsh fiber that it is not necessarily used too much and occupies 15% to 20% in the mixed feed. Since kaoliang tastes a little bitter and has a possibility that, when given too much in the feed, it can cause constipation, it occupies about 10% in the mixed feed.

Protein feed, containing 30% to 60% protein, occupies 5% to 30% of the mixed feed. Bean dregs and peanut dregs are good plant protein feed, having a good crispy taste and an over-all nutrition, and occupy 10% to 20% in the mixed feed. However, long-preserved peanut dregs are likely to produce aflatoxin G1. Since cotton seed dregs contain poisonous substance, it is not preferable for them to be given too much, preferably no more than 7% in the mixed feed. Fish powder, being the best animal protein, occupies 5% to 15% in the mixed feed. Considering its salt content, however, the salt content of the fish powder to be used should be less than 0.4% of the mixed feed. Moreover, the cost of the fish powder is expensive. The purpose of adding various protein feed is to keep the balance of amino acids.

Mineral feed mainly supplements the lack of mineral in the mixed feed and occupies 0.3% to 9% in the mixed feed. Bone powder supplements mainly calcium and phosphorus and occupies 2% to 3% in the mixed feed. Shell powder supplements mainly calcium and occupies would better to account for 8% to 10% in the mixed feed. Stone powder supplements calcium and calcium hydrophosphate supplements calcium and phosphorus. They occupy 10% to 12% in the mixed feed. Though they had better be used in large quantities for egg-laying hens, they must not be used too much for chickens except for the egg-laying hens. Though salt supplements sodium in the mixed feed and occupies 0.3% to 0.4% in the mixed feed, the salt content in the fish powder should be considered. Stone powder is easily available and inexpensive.

While breeding, the number of portions of Perilla seeds in 1000 portions of mixed feed may range from 5 to 200. The amount of Perilla seeds to be used may be adjusted according the demand of DHA amount in eggs. Eggs with different amount of DHA and ALA can meet different consumer groups. However, once the number of portions of Perilla seeds in the mixed seed exceeds 200, hens can absorb no more alpha-linolenic acid thus it will lead to waste. While if the number of portions of Perilla seeds is less than 5, the amount of DHA content in eggs produced by the hens will greatly lower and will not meet the desired amount. Moreover, vitamin E and green tea polyphenol are antioxidants.

In the present invention, after squeezing the oil from Perilla seeds, the oil and the dregs are together added to the feed to breed the hens. Thus, alpha-linolenic acid can be absorbed more easily. Alpha-linolenic acid is chemically called “octadecatrienoic acid,” and is converted into prostaglandin E3 and DHA, the reaction process of which is as follows:

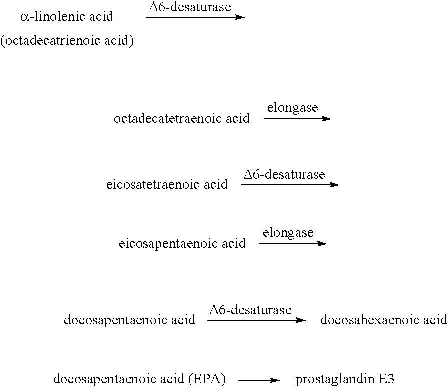

In the present invention, after a part of alpha-linolenic acid in Perilla seeds is absorbed by the hens, it is converted into docosahexaenoic acid and prostaglandin E3; the remaining part directly absorbed is ALA.

1. Feed for a hen producing eggs containing DHA, being mixed with 5 to 200 portions of oil obtained by squeezing Perilla seeds and dregs of the Perilla seeds to be a total of 1,000 portions.

2. Feed for a hen producing eggs containing DHA according to claim 1, also being mixed with 0.02 to 0.8 portions of vitamin E and 0.01 to 0.3 portions of green tea polyphenol.

3. Feed for a hen producing eggs containing DHA according to claim 1, comprising 650 to 895 portions of corn and bean dreg as main ingredients and a total of 100 to 150 portions of vitamins, minerals, calcium and phosphorus as supplementary ingredients according to a conventional proportion.

4. A method for breeding hens in which any one of the feed according to claims 1 to 3 is fed to hens twice a day for four successive weeks.

5. An egg produced by the hen bred by the method according to claim 4, containing 0.12 wt % to 0.38 wt % of DHA.

6. An egg according to claim 5, containing 0.13 wt % to 0.57 wt % of octadecatrienoic acid.
